(19) United States
(12) Patent Application Publication
(10) Pub. No.: US 2016/0042378 A1
(43) Pub. Date: Feb. 11, 2016

(54) TIME AND WAYPOINT-BASED INCENTIVES FOR MOBILE DEVICES

(71) Applicant: QUALCOMM Incorporated, San Diego, CA (US)

(72) Inventors: Rajarshi Gupta, Santa Clara, CA (US); Edward Thomas Lingham Hardie, Menlo Park, CA (US); Nayeem Islam, Palo Alto, CA (US)

(21) Appl. No.: 14/918,378

(22) Filed: Oct. 20, 2015

Related U.S. Application Data
(63) Continuation of application No. 12/533,443, filed on Jul. 31, 2009.
(60) Provisional application No. 61/160,997, filed on Mar. 17, 2009.

(51) Int. Cl. G06Q 30/02; H04W 4/02; H04W 4/14

(52) U.S. Cl. CPC G06Q 30/0207; H04W 4/14; H04W 4/025

(57) ABSTRACT

The subject matter disclosed herein relates to a system and method for receiving incentives on a mobile device. A first message may be received based on a first location of the mobile device, such that the first message indicates to a user of the mobile device that an incentive will be provided if the user remains within a certain proximity a waypoint for a predetermined length of time, and a second message including may be received if a second location of the mobile device is within the certain proximity of the waypoint, such that an elapsed time between a determination of the first location and a determination of the second location is equal to or greater than the predetermined length of time.

### CROSS-REFERENCES TO RELATED APPLICATIONS

This application is a continuation of U.S. patent application Ser. No. 12/533,443, filed on Jul. 31, 2009, entitled “Time and Waypoint Based Incentives for Mobiles,” which claims the benefit of U.S. Provisional Application No. 61/160,997, filed on Mar. 17, 2009, entitled “Time and Waypoint Based Incentives for Mobiles,” each of which is assigned to the assignee hereof, and incorporated herein in its entirety by reference.

### BACKGROUND

1. Field

The subject matter disclosed herein relates to providing time and waypoint-based incentives to mobile devices.

2. Information

There are different ways for determining the location of a mobile device, such as a cell phone, personal digital assistant (PDA), or any other mobile device. For example, some mobile devices may utilize a Satellite Positioning System (SPS) to determine their locations.

Many mobile devices have the ability to receive messages, such as Short Message Service (SMS) messages. Some wireless services providers may periodically send messages to their customers with incentives or offers to renew services. Alternatively, if a business entity, such as a restaurant, knows a particular customer's cell phone number, the business entity may transmit a coupon to the customer via a message. However, such messages may currently be sent to customers based solely on the fact the business entity knows the customer's cell phone number. For example, in the event that a customer lives in San Jose, Calif., a coupon to be used at a specific restaurant located in San Jose, Calif. could be sent via an SMS message to the customer's cell phone. However, if the customer is travelling on a business trip in Miami, Fla., a coupon which can be used only on a specified day at a restaurant located in San Jose, Calif., for example, may be a wasteful use of system resources and of the messaging limitations of the customer's cell phone because the customer may not be able to use the coupon while thousands of miles away on the business trip.

### BRIEF DESCRIPTION OF THE FIGURES

Non-limiting and non-exhaustive features will be described with reference to the following figures, wherein like reference numerals refer to like parts throughout the various figures.

FIG. 1 is an illustrative plan view of a shopping mall having waypoints that may provide incentives to mobile devices according to one implementation.

FIG. 2 is an illustrative block diagram of a system for providing messages containing incentives to a mobile device according to one implementation.

FIG. 3 is an illustrative plan view of a shopping area showing a user carrying a mobile device through an area according to one implementation.

FIG. 4 is an illustrative block diagram of a system for communicating between a circuitry located at a waypoint and a remote network via a hard wired connection according to one implementation.

FIG. 5 is a flow diagram illustrating a process for directing movement of a user by providing incentives to the user's mobile device according to one implementation.

FIG. 6 illustrates a particular implementation of a mobile device.

### SUMMARY

In one particular implementation, a system and method are provided for directing movement of a user of a mobile device. A determination may be made regarding whether a mobile device is within an area associated with one or more predefined waypoints. A “waypoint” may refer to a predefined or otherwise known location within an area. An incentive may be provided to the mobile device based at least in part on a location of the mobile device to influence behavior of a user of the mobile device. It should be understood, however, that this is merely an example implementation and that claimed subject matter is not limited in this respect.

### DETAILED DESCRIPTION

Reference throughout this specification to “one example”, “one feature”, “an example” or “a feature” means that a particular feature, structure, or characteristic described in connection with the feature and/or example is included in at least one feature and/or example of claimed subject matter. Thus, the appearances of the phrase “in one example”, “an example”, “in one feature” or “a feature” in various places throughout this specification are not necessarily all referring to the same feature and/or example. Furthermore, the particular features, structures, or characteristics may be combined in one or more examples and/or features.

A system may include one or more waypoints. A “waypoint,” as used herein may refer to a predefined or otherwise known location within an area. For example, a waypoint may be a known location within an indoor enclosure, such as a shopping mall. A waypoint in a shopping mall may be located within a particular store, or within a section of a store, in one implementation.

A wireless system may provide incentives specific to a user, for example, based on a user's proximity to certain predefined waypoints and/or to entice the user to move near a particular waypoint and/or remain near a particular waypoint for a threshold or otherwise designated amount of time and/or to influence the user to move in a direction toward at least one of one or more predefined waypoints. “Incentive,” as used herein, may refer to an inducement or benefit provided to a user of a mobile device to influence the user's behavior to, for example, encourage the user of the mobile device to move to a particular location and/or remain in a particular location, or purchase a particular item. In some implementations, an incentive may be provided after a user has remained in a particular location for a threshold length of time. Incentives may include coupons and/or some other type of financial benefit, such as free cell phone minutes, Internet access, and/or any other type of benefit that may influence a user's movement. An incentive may comprise a non-monetary benefit such as, for example, a promise of faster service. In one implementation, an incentive may be provided to a user to influence the user to move to a particular area, stay in the particular area for a certain length of time, and/or move to a different area. Incentives may be provided to direct users to various locations within a predefined or otherwise known area. It should be understood, however, that these are merely examples of incentives and that claimed subject matter is not limited in this respect.

In one particular example, upon a user of a mobile device entering a department store, a wireless system may provide an incentive to the user of the mobile device to encourage the user to move near an electronics department in which a waypoint is located. In one implementation, a user's mobile device may receive a Short Message Service (SMS) message containing a coupon for use in purchasing an item from an electronic department. In another implementation, a user may receive an incentive, such as a coupon, after remaining near a waypoint for a predefined amount of time. For example, after browsing an electronics section for ten minutes, a user's mobile device may receive a coupon for 20% off a Digital Versatile Disc (DVD).

In another implementation, such as an implementation utilized in a shopping mall scenario, an incentive may be provided to direct a user to a particular store. For example, there may be a waypoint located near a particular coffee shop, such as “Steve's Coffee Shop,” and, upon passing by the waypoint, an incentive, such as a coupon for a different coffee shop, such as “Joe's Coffee Shop,” may be provided to a user's mobile device.

A system may know locations of waypoints and a user's wireless service provider, for example, may provide incentives to a user. In one implementation, a user's mobile device may estimate its own location using one or more technologies described below and transmit one or more messages with this estimated location to its wireless service provider. Such a wireless service provider may determine whether the user is located near a waypoint, and provide incentives to direct the user to one or more nearby waypoints. In one implementation, various wireless devices of a wireless system may determine the location of a mobile device. For example, in the event that the mobile device is being held in an outdoor location, such as near an outdoor strip mall, Satellite Positioning System (SPS) coordinates for the mobile station may be determined Such an SPS may comprise a Global Positioning System (GPS), Galileo, GLONASS, NAVSTAR, or Quasi-Zenith Satellite System (QZSS), to name just a few examples of SPSs.

In one implementation, incentives may be provided by an entity other than a wireless service provider for a user of a mobile device. For example, if a wireless service provider determines that a mobile device is within a predefined threshold distance from a waypoint, the wireless service provider may send a message to a third party responsible for transmitting incentives. Upon receipt of such a message from the wireless service provider, the third party may send one or more incentives to the mobile device. Alternatively, a third party may receive a location of the mobile device from the mobile device itself or from some other system tracking movement of the mobile device.

In one implementation, the mobile device may estimate its own location by observing signals transmitted by nearby wireless devices. Such signals may comprise, for example, signals transmitted to wireless service providers for such wireless devices and/or short range signals such as, for example, Institute of Electrical and Electronics Engineers (IEEE) 802.11-compliant signals. In another implementation, a mobile device may estimate its own location by communicating with nearby access points, femtocells or base stations, for example. In one implementation, a transmitter associated with a waypoint may periodically broadcast messages to mobile devices within a predefined range. A receiver associated with the waypoint may receive messages from a location server tracking movement of a mobile device within a department store, for example. Such messages may indicate contact information for such a mobile device such as a number and/or address (e.g., email address) associated with the mobile device. Upon a user entering a department store, for example, messages containing different incentives, such as coupons, may be transmitted to a mobile device to direct the user to different departments within the store. A user may receive a message containing a coupon to use on certain electronics with an electronics department, and another coupon to use to purchase certain shoes within a shoe department.

In one implementation, a mobile device may estimate its own location by communicating with one or more nearby femtocells. A “femtocell,” as used herein, may refer to a small cellular base station. Such a femtocell may connect to a service provider's network via broadband (such as, for example, via Digital Subscriber Line (DSL) or cable). A femtocell may, for example, utilize a technology such as Universal Mobile Telecommunications System (UTMS), Long Term Evolution (LTE), Evolution-Data Optimized or Evolution-Data only (EV-DO), Global System for Mobile communications (GSM), Worldwide Interoperability for Microwave Access (WiMAX), Code division multiple access (CDMA)-2000, or Time Division Synchronous Code Division Multiple Access (TD-SCDMA), to name just a few among many possible technologies compatible with femtocells.

In some implementations, a user may receive a message indicating that a certain incentive will be provided if the user remains near a particular waypoint for a predefined length of time. For example, a message may indicate that a user would receive a 10% off coupon if the user remains in an electronics department for at least ten minutes. Such an incentive may therefore entice a user to browse items within an electronic department that the user might otherwise have ignored.

In some implementations, certain habits of a user may be tracked and an incentive may be provided based on such habitual behavior, e.g., purchases initiated by the user. For example, a user's shopping history may be stored in a database and an incentive may be provided to the user based on the user's shopping history. For example, if the user's shopping history indicates that the user frequently purchases chocolate items, a coupon to be used for chocolate candy may be provided to the user as an incentive, for example, when the user is near a grocery store.

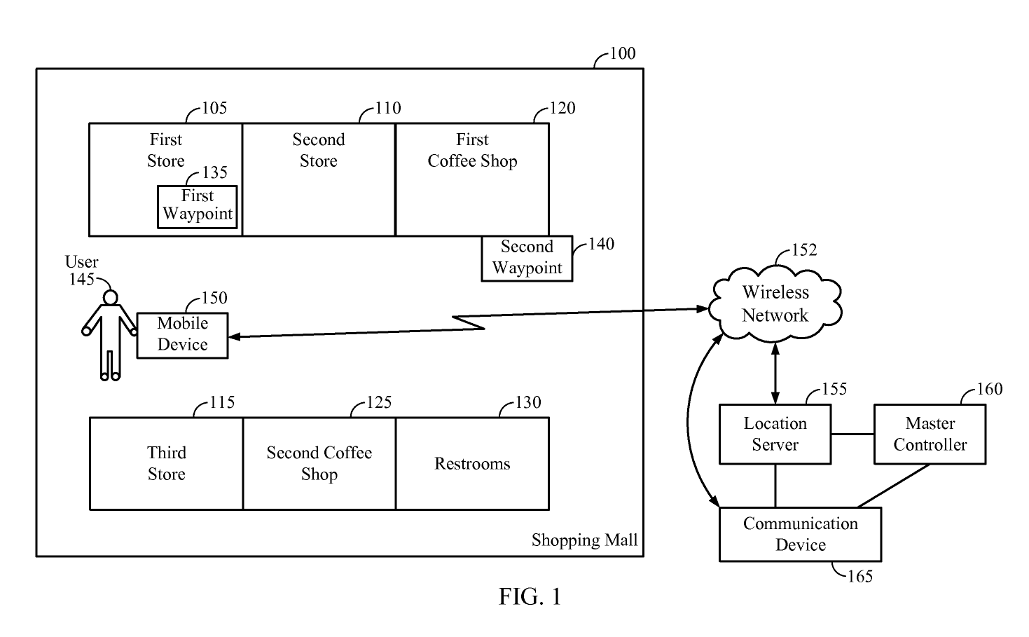

FIG. 1 is a plan view of a shopping mall 100 having waypoints that may provide incentives to mobile devices according to one implementation. As shown, shopping mall 100 includes multiple stores or shops, including a first store 105, a second store 110, a third store 115, a first coffee shop 120, a second coffee shop 125, and restrooms 130. Waypoints may be dispersed in various locations of shopping mall 100. In this particular example, a first waypoint 135 is located within first store 105, and a second waypoint 140 is located just outside first coffee shop 120. It should be appreciated that more, or fewer, stores and/or waypoints may be utilized in other implementations. In one particular implementation, for example, each store or shop may include at least one waypoint of its own.

FIG. 1 also illustrates a user 145 carrying a mobile device 150. Mobile device 150 may be a cell phone, Personal Digital Assistant (PDA), wireless notebook, or any other type of electronic device capable of receiving and/or transmitting wireless communications to communicate with a network. Such wireless communications may include messages, such as SMS messages, voicemail messages, and/or email messages, to name just a few examples. User 145 may walk through shopping mall 100 and receive incentives via mobile device 150. Such incentives may direct user 145 to a particular waypoint and/or reward user 145 for remaining near a particular waypoint for a certain length of time.

As user 145 moves through shopping mall 100, mobile device 150 may receive a message containing an incentive associated with first waypoint 135. For example, mobile device 150 may receive a message containing a coupon for use in purchasing certain items at first store 105. Alternatively, a message containing an incentive may be provided in the event that mobile device 150 remains within a certain proximity of first waypoint 135 for a predefined length of time. Such a threshold time duration may encourage user 145 to remain within first store 105 and browse items for sale. For example, in the event that first store 105 is a bookstore, first waypoint 135 may provide a 20% off coupon to be utilized on a book after mobile device 150 is determined to have remained within a predefined proximity of first waypoint 135 for five minutes.

As discussed, an incentive may be provided via a wirelessly transmitted message, such as an SMS message, or any other messaging technology. Alternatively, an incentive may be provided via a phone call, voice mail, and/or email provided to mobile device 150. A user may redeem a particular incentive by, for example, showing mobile device 150 to a salesperson. In the event that an incentive is a coupon transmitted via an SMS message, a coupon code may be included within the SMS message. In some implementations, an incentive may not be advertised and a user may request such an incentive. In some implementations, for example, an incentive may not be advertised to all users; to receive such an incentive, a user may subscribe to a service or otherwise indicate a willingness to receive the incentive. If an incentive is non-monetary (e.g., for a shorter security line at airport), a user may receive the benefit of the incentive by following instructions pertaining to the incentive that may be transmitted to the user's mobile device 150.

FIG. 1 illustrates an implementation in which incentives are provided by a service provider for user 145 of mobile device 150. In this implementation, mobile device 150 may be in communication with wireless network 152. Wireless network 152 may also be in communication with a location server 155. Location server 155 may store a map or other representation of waypoints within a given area. Alternatively, location server 155 may be in communication with another entity in which such a map or representation is stored. Location server 155 may periodically estimate a current location of user 145 of mobile device 150. Such an estimate may be based upon an SPS technology, such as GPS, Galileo, GLONASS, NAVSTAR, QZSS, or any other type of satellite positioning system to determine a location of mobile station 150. However, there may be certain situations in which navigation signals from an SPS may not be available, such as in the event that user 145 is carrying mobile device 150 within a building in which navigation signals from one or more SPSs are unavailable.

In some implementations, SPS coordinates may be estimated for mobile device 150. For example, if user 145 carries mobile device 150 from an area where navigation signals from an SPS are available, such as in an outdoor area, into an area where such navigation signals are unavailable, mobile device 150 may have a precise estimate of its SPS coordinates at the time when navigation signals are available. Thereafter, upon entering an area where such navigation signals are unavailable, mobile device 150 may, for example, estimate its position as user 145 carries mobile device 150. For example, mobile device 150 may include one or more accelerometers, gyroscopes, and/or any other devices capable of measuring movement of mobile device 150. Accordingly, based on detected movement, mobile device 150 may estimate how far and in which direction mobile device 150 has moved since its location was previously estimated based on navigation signals, for example.

There are additional ways in which a location of mobile device 150 may be determined within an area in which navigation signals from an SPS are unavailable. For example, there may be devices located within an area that have known, fixed locations. For example, electronic devices with fixed and known locations may be dispersed throughout a shopping mall. Such electronic devices may transmit navigation signals and mobile device 150 may triangulate its location based on such navigation signals. In an area where navigation signals are unavailable, for example, a mobile device may estimate its own location by observing signals transmitted by nearby wireless devices. Such signals may comprise, for example, signals transmitted to wireless service providers for such wireless devices and/or short range signals such as, for example, Institute of Electrical and Electronics Engineers (IEEE) 802.11-compliant signals, or signals transmitted to nearby femtocells. A mobile device's presence within an area associated with one or more predefined waypoints may be determined by receiving, by the mobile device, one or more wireless signals having location information from one or more wireless devices within a predefined range of the mobile device.

Many different types of incentives may be provided to mobile device 150, including coupons, offers for free Internet access, free wireless service minutes, free text messaging capabilities, and/or any other type of information. For example, if first store 105 is a cell phone store, a user may receive free minutes or discounts on certain wireless service plans if user 145's mobile device 150 remains within a certain proximity of first waypoint 135 for a certain length of time.

User 145 may move through shopping mall 100 in a direction toward first coffee shop 120. As shown, second waypoint 140 may be located just outside of first coffee shop 120. If user 145 is within a close proximity of second waypoint 140, an incentive may be provided to user 145 to entice user 145 to visit second coffee shop 125. In other words, an incentive may be provided to encourage user 145 to purchase items, such as coffee, at second coffee shop 125 instead of at first coffee shop 120.

In one implementation, user 145's wireless service provider, for example, may keep track of a location of mobile device 150 and may transmit one or more incentives to mobile device 150. For example, mobile device 150 may periodically transmit its location to a wireless network 152. Alternatively, mobile device 150 may transmit its location to a local receiver, for example, located within shopping mall 100 and a transmitter associated with such a receiver may transmit the location of mobile device 150 to location server 155. In an additional implementation, a receiver located within shopping mall 100 may receive a communication from mobile device 150 and may thereafter transmit a message to location server 155 to indicate that mobile device 150 is located somewhere near the receiver.

A location detected for mobile device 150 may be sent through wireless network 152 to a location server 155. Location server 155 may have information about locations of various waypoints, such as first waypoint 135 and second waypoint 140 within shopping mall 100. Based on a periodically updated location of mobile device 150, location server 155 may determine whether mobile device 150 is near any waypoints, for example. A master controller 160 may be in communication with location server 155 and may determine whether to send one or more incentive to mobile device 150. Specifically, master controller 160 may determine which incentive(s) to send to mobile device 150 to influence movement of user 145 through shopping mall 100. Based on location information stored in location server 155, master control 160 may direct a communication device 165 to transmit one or more incentives through wireless network 152 to mobile device 150. Although location server 155, master control 160, and communication device 165 are shown as being separate entities in FIG. 1, it should be appreciated that in some implementations, one or more of location server 155, master control 160, and communication device 165 may be contained within a single device or component.

Alternatively, an incentive may be transmitted from a local area network to mobile device 150. For example, a wireless transmitter located at a waypoint may transmit an incentive to mobile device 150 if mobile device is within a predefined distance from such a waypoint. In order to transmit such an incentive, an identity of mobile device 150 may first be determined. For example, to send an SMS message to mobile device 150, a telephone number of mobile device 150 may first be obtained by such a transmitter. A telephone number for mobile device 150 may be provided to such a transmitter by communication device 165 under the control of master controller 160. For example, master controller 160 may direct communication device 165 to transmit a message to first waypoint 135 if, based at least in part on location information for the waypoints accessible by and provided by location server 155, it is determined that mobile device 150 is within a predefined distance from first waypoint 135. Such a message transmitted to first waypoint 135 may include a phone number for mobile device 150. Alternatively, other contact information such as an email address may be transmitted to a transmitter/receiver for first waypoint 135. Upon receiving such information, a transmitter for first waypoint 135 may transmit one or more incentives to mobile device 150.

In one particular implementation, a waypoint may be associated with an access point or wireless local area network (WLAN) having a transmitter to directly transmit one or more messages with an incentive to mobile device 150. Alternatively, as discussed above, mobile device 150 may determine and transmit its location to location server 155 for a wireless service provider, and the wireless service provider may determine whether mobile device 150 is near any waypoints and, if so, may provide incentives to mobile device 150. For example, a wireless service provider may have access to a map or almanac of locations of waypoints and may determine whether mobile device 150 is within a predefined distance of any of such waypoints based, for example, on the location transmitted by mobile device to the wireless service provider.

One or more incentives may also be provided to a user based on behavior of the user, e.g., movement of the user, a particular travel route followed by the user, etc. For example, if user 145 carries mobile device 150 to first store 105, first coffee shop 120, and then third store 115, in this particular order, an incentive specific to this route may be provided to user 145. Alternatively, if user 145 carries mobile device 150 to third store 115, second coffee shop 125, and then to second store 110, in this particular order, an incentive specific to this particular route may instead be provided to user 145. Route-based incentives may also be used in some implementations, for example, to direct flow of traffic. For example, a particular incentive, such as a coupon for a gasoline discount, may be provided to reward a user for following a particular exit route from a parking garage of a shopping mall or for taking a less congested route during rush hour. One or more incentives (e.g., incentives with time limits) may be provided to influence the user to move along a predefined route toward at least two waypoints. For example, two coupons, one for a discount at first coffee shop 120 that expires in the next half hour and one for a discount at first store 105 that expires in the next hours, may be sent to the user to influence the user to move toward first coffee shop 120 (second waypoint 140) and then toward first store 105 (first waypoint 135).

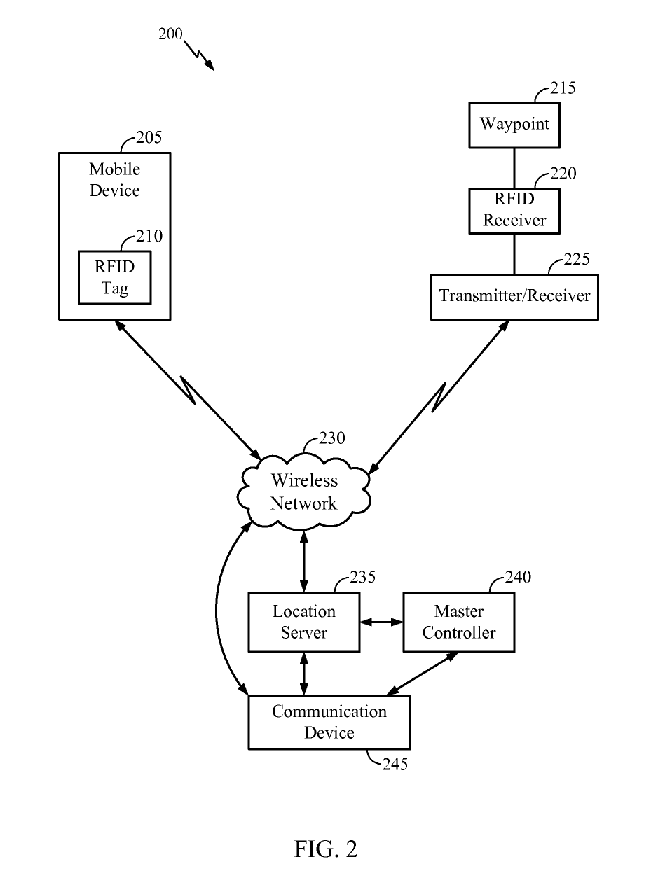

FIG. 2 is a block diagram illustrating a system 200 for providing messages containing incentives to a mobile device 205 according to one implementation. In the implementation shown in FIG. 2, mobile device 205 includes a Radio Frequency Identification (RFID) tag 210. RFID tag 210 may include an identifier associated with mobile device 205. If mobile device 205 is moved near a particular waypoint 215, an RFID receiver 220 for waypoint 215 may acquire the identifier from RFID tag 210. For example, RFID receiver 220 may read and/or receive a signal from RFID tag 210 which includes the identifier for mobile device 205. Such an identifier may include contact information for mobile device 205, such as a phone number, email address, and/or a type of preferred communication method for receiving an incentive. Alternatively, such an identifier may be a number or code which may be referenced in a database or lookup table to determine a phone number, email address, and/or a type of preferred communication method for receiving a message containing incentive(s) for mobile device 205.

If RFID receiver 220 receives an identifier from RFID tag 210, a transmitter/receiver 225 associated with waypoint 215 may transmit a message via a wireless network 230 to location server 235 to indicate that mobile device 205 is located near waypoint 215. Location server 235 may contain information indicating whether incentive(s) are to be provided to mobile device 205 based at least partially on a proximity between mobile device 205 and waypoint 215. A master controller 240 may control location server 235 and direct communication device 245 to transmit incentive(s) via wireless network 230 to mobile device 205. Alternatively, communication device 245 may transmit a message to transmitter/receiver 225 indicating which incentive(s) to provide to mobile device 205. Upon receiving such a message from communication device 245, transmitter/receiver 225 may transmit an incentive to mobile device 205.

Although transmitter/receiver 225 is shown as being in wireless communication with location server 235 and/or communication device 245 via wireless network 230, it should be appreciated that in some implementations, there may be a hard-wired connection between transmitter/receiver 225 and location server 235 and/or communication device 245. For example, transmitter/receiver 225 may communicate with location server 235 and/or communication device 245 via the Internet or some other network involving hard-wired connections.

In another implementation, an RFID tag may be associated with a particular waypoint. Such an RFID tag may, for example, be affixed to a wall near a waypoint. Such an RFID tag may be read by a receiver within mobile device 205. Mobile device 205 may subsequently relay the identity of the RFID tag to location server 235, for example.

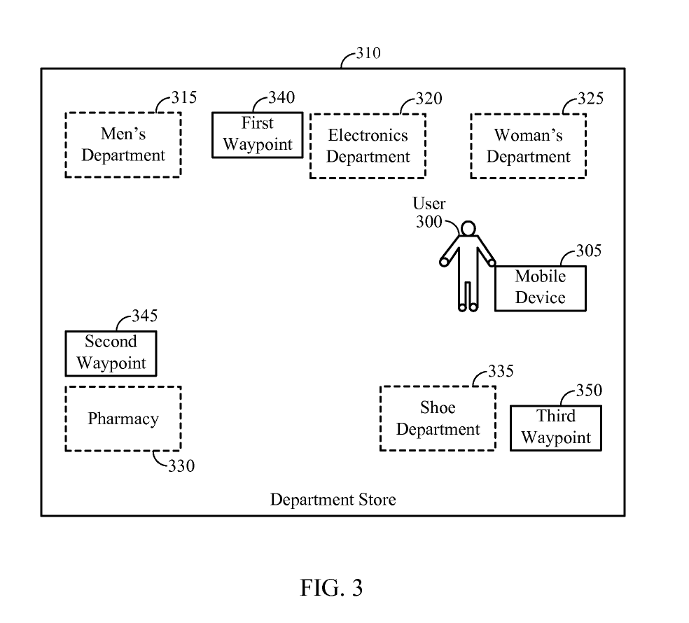

FIG. 3 illustrates a plan view of a shopping area showing a user 300 carrying a mobile device 305 through an area according to one implementation. In this example, user 300 may move through a department store 310. Department store 310 may include various departments, such as a Men's Department 315, an Electronics Department 320, a Women's Department 325, a Pharmacy 330, and a Shoe Department 335. There may also be various waypoints located throughout department store 310, such as a first waypoint 340, a second waypoint 345, and a third waypoint 350.

A message containing an incentive may be provided to direct user 300 to various locations, for example, to encourage user 300 to shop in certain departments. For example, user 300 may receive a message containing an incentive to direct user 300 to first waypoint 340 and/or reward user 300 for remaining within a predefined proximity of first waypoint 340 for a predefined threshold length of time. Such an incentive may encourage user 300 to shop in Electronics Department 320. As discussed, such a message containing an incentive may be transmitted to mobile device 305 from a remote wireless network and/or from a local device, such as a transmitter associated with first waypoint 340.

Here, for example, a coupon to be utilized for the purchase of a TV may be provided to user 300's mobile device 305. Messages containing incentives may also be provided if user 300 is near a second waypoint 345 to encourage user 300 to purchase items in Pharmacy 330. Similarly, messages containing incentives may be provided if user 300 moves near third waypoint 350 to encourage user 300 to shop in Shoe Department 335.

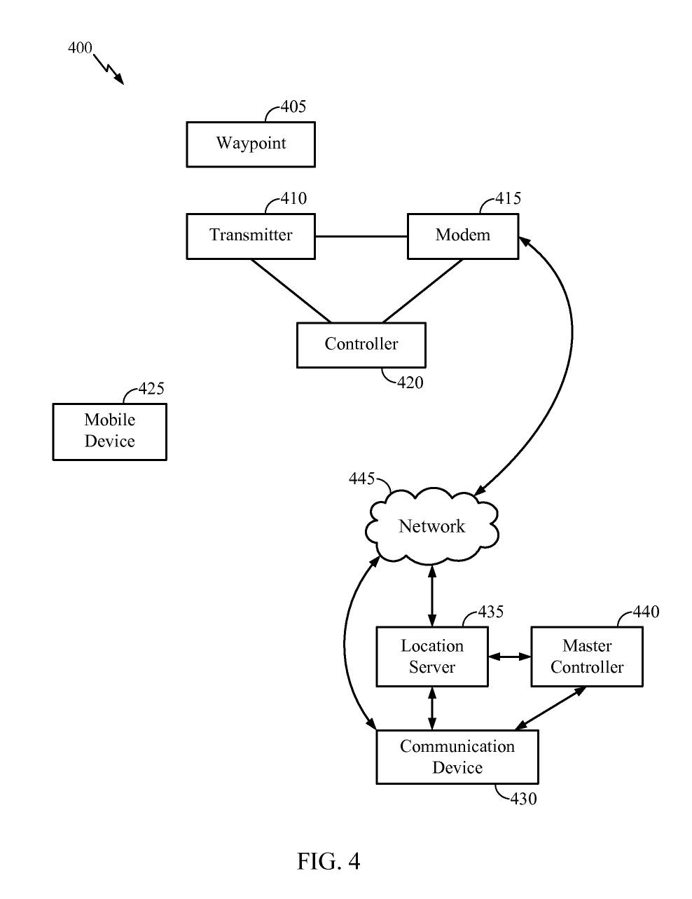

FIG. 4 is an illustrative block diagram of a system 400 for communicating between a circuitry located at a waypoint 405 and a remote network via a hard wired connection according to one implementation. In FIG. 4, a transmitter 410, modem 415, and a controller 420 may be associated with a waypoint 405. In some implementations, transmitter 410 may transmit incentives via messages, such as SMS messages, for example, to a mobile device 425.

A mobile device 425 may periodically transmit its location to a communication device 430 via a wireless network, for example. Communication device 430 may transmit a location for mobile device 425 to a location server 435. A master controller 440 may control operations of communication device 430 and location server 435. Based on movement of mobile device 425, master controller 440 may determine whether to provide incentive(s) to mobile device 425. In this example, master controller 440 may direct communication device 430 to transmit a message via a network 445. Network 445 may be a hard-wired network, such as a landline telephone network or Digital Subscriber Line (DSL) or cable, for example. A message from communication device 430 may be received from network 445 via modem 415 indicating which incentive(s) to provide to mobile device 425. Upon receipt of such a message, controller 420 may direct transmitter 410 to transmit one or more incentives to mobile device 425, for example. Although FIG. 4 illustrates an example where an incentive is transmitted to mobile device 425 from transmitter 410 associated with a waypoint, it should be appreciated that in some implementations, such an incentive may be transmitted wirelessly from remote communication device 430, in a manner similar to that discussed.

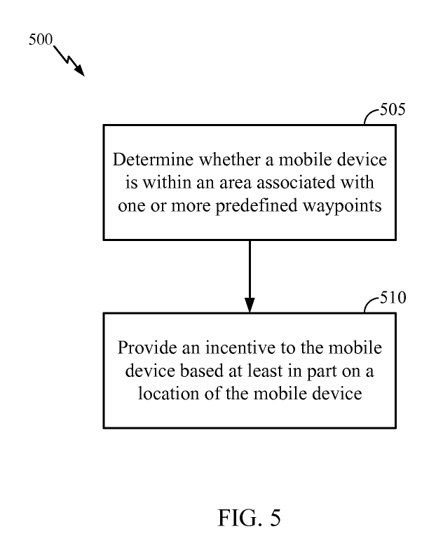

FIG. 5 is a flow diagram illustrating a process 500 for directing movement of a user by providing incentives to the user's mobile device according to one implementation. First, at operation 505, a determination is made as to whether a mobile device is within an area associated with one or more predefined waypoints. Such a determination may be made be a location server, for example. Next, at operation 510, an incentive may be provided to the mobile device based at least in part on a location of the mobile device to direct movement of a user of the mobile device in a direction toward at least one of the one or more predefined waypoints.

Circuitry, such as transmitters and/or receivers for one or more waypoints, may provide functionality, for example, through the use of various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as CDMA2000, Wideband-CDMA (W-CDMA), and so on. CDMA2000 includes IS-95, IS-2000, and IS-856 standards. A TDMA network may implement Global System for Communications (GSM), Digital Advanced Phone System (D-AMPS), or some other RAT. GSM and W-CDMA are described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN. The techniques may be implemented for use with a Ultra Mobile Broadband (UMB) network, a High Rate Packet Data (HRPD) network, a CDMA2000 1× network, GSM, Long-Term Evolution (LTE), and/or the like.

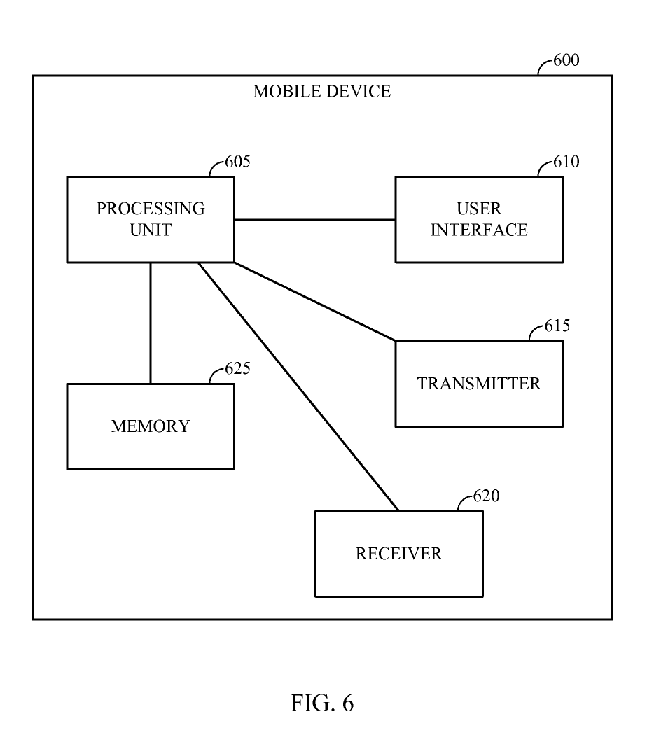

FIG. 6 shows a particular implementation of a mobile device 600 according to one implementation. Mobile device 600 may comprise a mobile station (MS) in which a radio transceiver may be adapted to modulate an RF carrier signal with baseband information, such as voice or data, onto an RF carrier, and demodulate a modulated RF carrier to obtain such baseband information.

Mobile device 600 may include several elements such as processing unit 605, user interface 610, transmitter 615, receiver 620, and memory 625. User interface 610 may comprise a plurality of devices for inputting or outputting user information such as voice or data. Such devices may include, for example, a keyboard, a display screen, a microphone, a speaker, buttons and knobs, just to name a few examples.

Memory 625 may be adapted to store machine-readable instructions, which are executable to perform one or more of processes, examples, or implementations thereof which are described or suggested. Processing unit 605 may be adapted to access and execute such machine-readable instructions. Through execution of these machine-readable instructions, processing unit 605 may direct various elements of mobile device 600 to perform one or more functions.

Transmitter 615 may utilize an antenna to transmit communications, such as packet-based communications, to other devices. Receiver 620 may also utilize such an antenna to receive communications, such as packet-based communications, from other devices.

Some portions of the detailed description are presented in terms of algorithms or symbolic representations of operations on binary digital signals stored within a memory of a specific apparatus or special purpose computing device or platform. In the context of this particular specification, the term specific apparatus, special purpose apparatus, or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm as here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. For example, a specific computing apparatus, a special purpose apparatus, or the like may comprise one or more processing units programmed with instructions to perform one or more specific functions.

Methodologies described herein may be implemented by various means depending upon applications according to particular features and/or examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other device units designed to perform the functions described herein, and/or combinations thereof.

Certain methodologies may be implemented with modules (e.g., procedures, functions, and so on) that perform the functions described herein. Any machine readable medium tangibly embodying instructions may be used in implementing the methodologies described herein. For example, software codes may be stored in a memory of a mobile station and/or an access point and executed by a processing unit of the device. Memory may be implemented within a processing unit and/or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. A computer-readable medium may take the form of an article of manufacture. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing unit having a command set which includes the encoded commands. Such an instruction may be encoded in the form of a machine language understood by the processing unit. Again, these are merely examples of an instruction and claimed subject matter is not limited in this respect.

As used herein, a mobile station (MS) refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method of receiving incentives on a mobile device, comprising:
receiving a first message based on a first location of the mobile device, wherein the first message indicates to a user of the mobile device that an incentive will be provided if the user remains within a certain proximity a waypoint for a predetermined length of time; and
receiving a second message including the incentive if a second location of the mobile device is within the certain proximity of the waypoint, wherein an elapsed time between a determination of the first location and a determination of the second location is equal to or greater than the predetermined length of time.

2. The method of claim 1, wherein a contact information associated with the user is used to receive the first message and the second message.

3. The method of claim 1, wherein the incentive comprises a coupon redeemable for goods or services, access to one or more wireless services, and/or information.

4. The method of claim 1, comprising determining the first location with the mobile device, and transmitting the first location of the mobile device to a wireless network.

5. The method of claim 1, comprising determining the second location with the mobile device, and transmitting the second location of the mobile device to a wireless network.

6. The method of claim 1, comprising transmitting an identifier from a Radio Frequency Identifier (RFID) tag associated with the mobile device.

7. The method of claim 1, wherein the first message or the second message are received via a Short Message Service (SMS).

8. The method of claim 1, wherein the first message or the second message are received via an electronic mail (email).

9. The method of claim 1, comprising:
transmitting a plurality of current locations of the mobile device, wherein each of the plurality of current locations is periodically transmitted during a duration of time beginning when the first message is received and continuing for at least the predetermined length of time; and
receiving the second message including the incentive if each of the plurality of current locations and the second location are within the certain proximity of the waypoint.

10. An apparatus for of receiving location based incentives, comprising:
a memory;
a receiver;
at least one processing unit operably coupled to the memory and the receiver, and configured to:
receive a first message based on a first location of a mobile device, wherein the first message indicates to a user of the mobile device that an incentive will be provided if the user remains within a certain proximity a waypoint for a predetermined length of time; and
receive a second message including the incentive if a second location of the mobile device is within the certain proximity of the waypoint, wherein an elapsed time between a determination of the first location and a determination of the second location is equal to or greater than the predetermined length of time.

11. The apparatus of claim 10, wherein a contact information associated with the user is used to receive the first message and the second message.

12. The apparatus of claim 10, wherein the incentive comprises a coupon redeemable for goods or services, access to one or more wireless services, and/or information.

13. The apparatus of claim 10, further comprising a transmitter operably coupled to the at least one processing unit, wherein the at least one processing unit is further configured to determine the first location, and the transmitter is configured to transmit the first location of the mobile device to a wireless network.

14. The apparatus of claim 13, wherein the at least one processing unit is configured to determine the second location, and the transmitter is configured to transmit the second location of the mobile device to the wireless network.

15. The apparatus of claim 10, wherein a transmitter is configured to transmit an identifier from a Radio Frequency Identifier (RFID) tag associated with the mobile device.

16. The apparatus of claim 10, wherein the first message or the second message are received via a Short Message Service (SMS).

17. The apparatus of claim 10, wherein the first message or the second message are received via an electronic mail (email).

18. The apparatus of claim 10, wherein the at least one processing unit is further configured to:
determine a plurality of current locations of the mobile device, wherein each of the plurality of current locations is periodically transmitted during a duration of time beginning when the first message is received and continuing for at least the predetermined length of time; and
receive the second message including the incentive if each of the plurality of current locations and the second location are within the certain proximity of the waypoint.

19. An apparatus for receiving incentives on a mobile device, comprising:
means for receiving a first message based on a first location of the mobile device, wherein the first message indicates to a user of the mobile device that an incentive will be provided if the user remains within a certain proximity a waypoint for a predetermined length of time; and
means for receiving a second message including the incentive if a second location of the mobile device is within the certain proximity of the waypoint, wherein an elapsed time between a determination of the first location and a determination of the second location is equal to or greater than the predetermined length of time.

20. The apparatus of claim 19, wherein a contact information associated with the user is used to receive the first message and the second message.

21. The apparatus of claim 19, wherein the incentive comprises a coupon redeemable for goods or services, access to one or more wireless services, and/or information.

22. The apparatus of claim 19, comprising means for determining the first location with the mobile device, and means for transmitting the first location of the mobile device to a wireless network.

23. The apparatus of claim 19, comprising means for determining the second location with the mobile device, and means for transmitting the second location of the mobile device to a wireless network.

24. The apparatus of claim 19, comprising means for transmitting an identifier from a Radio Frequency Identifier (RFID) tag associated with the mobile device.

25. The apparatus of claim 19, wherein the first message or the second message are received via a Short Message Service (SMS).

26. The apparatus of claim 19, wherein the first message or the second message are received via an electronic mail (email).

27. The apparatus of claim 19, comprising:
means for transmitting a plurality of current locations of the mobile device, wherein each of the plurality of current locations is periodically transmitted during a duration of time beginning when the first message is received and continuing for at least the predetermined length of time; and
means for receiving the second message including the incentive if each of the plurality of current locations and the second location are within the certain proximity of the waypoint.

28. A non-transitory processor-readable storage medium comprising instructions for receiving incentives on a mobile device, the instructions comprising:
code for receiving a first message based on a first location of the mobile device, wherein the first message indicates to a user of the mobile device that an incentive will be provided if the user remains within a certain proximity a waypoint for a predetermined length of time; and
code for receiving a second message including the incentive if a second location of the mobile device is within the certain proximity of the waypoint, wherein an elapsed time between a determination of the first location and a determination of the second location is equal to or greater than the predetermined length of time.

29. The non-transitory processor-readable storage medium of claim 28, wherein a contact information associated with the user is used to receive the first message and the second message.

30. The non-transitory processor-readable storage medium of claim 28, wherein the incentive comprises a coupon redeemable for goods or services, access to one or more wireless services, and/or information.

31. The non-transitory processor-readable storage medium of claim 28, comprising code for determining the first location with the mobile device, and code for transmitting the first location of the mobile device to a wireless network.

32. The non-transitory processor-readable storage medium of claim 28, comprising code for determining the second location with the mobile device, and code for transmitting the second location of the mobile device to a wireless network.

33. The non-transitory processor-readable storage medium of claim 28, comprising code for transmitting an identifier from a Radio Frequency Identifier (RFID) tag associated with the mobile device.

34. The non-transitory processor-readable storage medium of claim 28, wherein the first message or the second message are received via a Short Message Service (SMS).

35. The non-transitory processor-readable storage medium of claim 28, wherein the first message or the second message are received via an electronic mail (email).
